(19) United States
(12) Patent Application Publication
(10) Pub. No.: US 2017/0206050 A1
(43) Pub. Date: Jul. 20, 2017

(54) CONTENT SHARING METHODS AND APPARATUSES

(71) Applicant: Beijing Zhigu Rui Tuo Tech Co., Ltd, Beijing (CN)

(72) Inventor: Jia LIU, Beijing (CN)

(73) Assignee: Beijing Zhigu Rui Tuo Tech Co., Ltd., Beijing (CN)

(21) Appl. No.: 15/326,433

(22) PCT Filed: Jun. 5, 2015
(86) PCT No.: PCT/CN2015/080835

§ 371 Date: Jan. 13, 2017

(30) Foreign Application Priority Data
Jul. 18, 2014 (CN) 201410344898.4

(51) Int. Cl. G06F 3/14; G09G 5/12

(52) U.S. Cl. CPC G06F 3/1454; G09G 5/12; G09G 2340/0407; G09G 2370/18

(57) ABSTRACT

Content sharing methods and apparatuses are provided that relate to the field of communications. A method comprises: determining a projection region of a second display region of a second display device on a first display region of a first display device; and sending related information of the projection region to the second display device. The methods and apparatuses can simplify content sharing steps, improve content sharing efficiency and/or enhance user experience.

### RELATED APPLICATION

The present international patent cooperative treaty (PCT) application claims the benefit of priority to Chinese Patent Application No. 201410344898.4, filed on Jul. 18, 2014, and entitled “Content Sharing Method and Apparatus”, which is hereby incorporated into the present international PCT application by reference herein in its entirety.

### TECHNICAL FIELD

The present application relates to the field of communications, and in particular, to content sharing methods and apparatuses.

### BACKGROUND

With development of technologies, new display devices such as near-to-eye display devices (for example, smart glasses) and transparent screens constantly emerge, and users have more abundant and more convenient content display ways. However, compared with the traditional mobile devices (for example, smart phones and tablet computers), although the new display devices have advantages of great field of vision, being easy to wear and the like, the new display devices still have some disadvantages in aspects such as screen resolution and display effects (color saturation, brightness and contrast); while the traditional mobile devices have developed for several years, and display effects, pixel density thereof and the like have reached a higher level. Therefore, making full use of respective advantages of the traditional mobile devices and the new devices to perform display interaction and content sharing between the two kinds of devices will provide greater convenience for users.

Generally, sharing local content in which a user is interested in display content from a display device A to a display device B comprises the following steps: 1) establishing a communication connection between the device A and the device B; 2) sending, by the device A, the display content to the device B; 3) receiving, by the device B, the display content; and 4) obtaining, by the user, a region of interest through a corresponding operation (for example, zoom or take a screenshot) on the device B. The process has tedious steps, takes more time and has poor user experience.

### SUMMARY

The following presents a simplified summary of the disclosed subject matter in order to provide a basic understanding of some aspects of the disclosed subject matter. This summary is not an extensive overview of the disclosed subject matter. It is intended to neither identify key or critical elements of the disclosed subject matter nor delineate the scope of the disclosed subject matter. Its sole purpose is to present some concepts of the disclosed subject matter in a simplified form as a prelude to the more detailed description that is presented later.

An example, non-limiting objective of the present application is to provide content sharing methods and apparatuses.

According to one aspect of at least one example embodiment of the present application, a content sharing method is provided, the method comprising:

determining a projection region of a second display region of a second display device on a first display region of a first display device; and

sending related information of the projection region to the second display device.

According to another aspect of the at least one example embodiment of the present application, a content sharing method is provided, the method comprising:

determining position information of a projection region of a second display region of a second display device on a first display region of a first display device; and

acquiring related information of the projection region from the first display device according to the position information.

According to another aspect of the at least one example embodiment of the present application, a content sharing apparatus is provided, the apparatus comprising:

a determination module, configured to determine a projection region of a second display region of a second display device on a first display region of a first display device; and

a sending module, configured to send related information of the projection region to the second display device.

According to another aspect of the at least one example embodiment of the present application, a content sharing apparatus is provided, the apparatus comprising:

a determination module, configured to determine position information of a projection region of a second display region of a second display device on a first display region of a first display device; and

an acquisition module, configured to acquire related information of the projection region from the first display device according to the position information.

The content sharing methods and apparatuses according to the example embodiments of the present application can simplify content sharing steps, improve content sharing efficiency and/or enhance user experience.

### BRIEF DESCRIPTION OF THE DRAWINGS

FIG. 1 is a flowchart of a content sharing method according to one example embodiment of the present application;

FIG. 2 is a schematic diagram of the projection region in one example embodiment of the present application;

FIG. 3 is a flowchart of step S120 in one example embodiment of the present application;

FIG. 4 is a flowchart of the content sharing method in one example embodiment of the present application;

FIG. 5 is a schematic diagram of the prompt information in one example embodiment of the present application;

FIG. 6 is a flowchart of the content sharing method according to another example embodiment of the present application;

FIG. 7 is a flowchart of step S620 in one example embodiment of the present application;

FIG. 8 is a schematic diagram of the projection region in another example embodiment of the present application;

FIG. 9 is a flowchart of step S640 in one example embodiment of the present application;

FIG. 10 is a flowchart of step S640 in another example embodiment of the present application;

FIG. 11 is a schematic diagram of a modular structure of the content sharing apparatus according to one example embodiment of the present application;

FIG. 12 is a schematic diagram of a modular structure of the determination module in one example embodiment of the present application;

FIG. 13 is a schematic diagram of a modular structure of the content sharing apparatus in one example embodiment of the present application;

FIG. 14 is a schematic diagram of a modular structure of the content sharing apparatus according to another example embodiment of the present application;

FIG. 15 is a schematic diagram of a modular structure of the determination module in one example embodiment of the present application;

FIG. 16 is a schematic diagram of a modular structure of the acquisition module in one example embodiment of the present application;

FIG. 17 is a schematic diagram of a modular structure of the acquisition module in another example embodiment of the present application;

FIG. 18 is a schematic diagram of a hardware structure of the content sharing apparatus according to one example embodiment of the present application; and

FIG. 19 is a schematic diagram of a hardware structure of the content sharing apparatus according to another example embodiment of the present application.

### DETAILED DESCRIPTION

Example embodiments of the present application are described in detail hereinafter with reference to the accompanying drawings and embodiments. The following embodiments are intended to describe the present application, but not to limit the scope of the present application.

It should be understood by those skilled in the art that, in the embodiments of the present application, the value of the serial number of each step described above does not mean an execution sequence, and the execution sequence of each step should be determined according to the function and internal logic thereof, and should not be any limitation to the example embodiments of the present application.

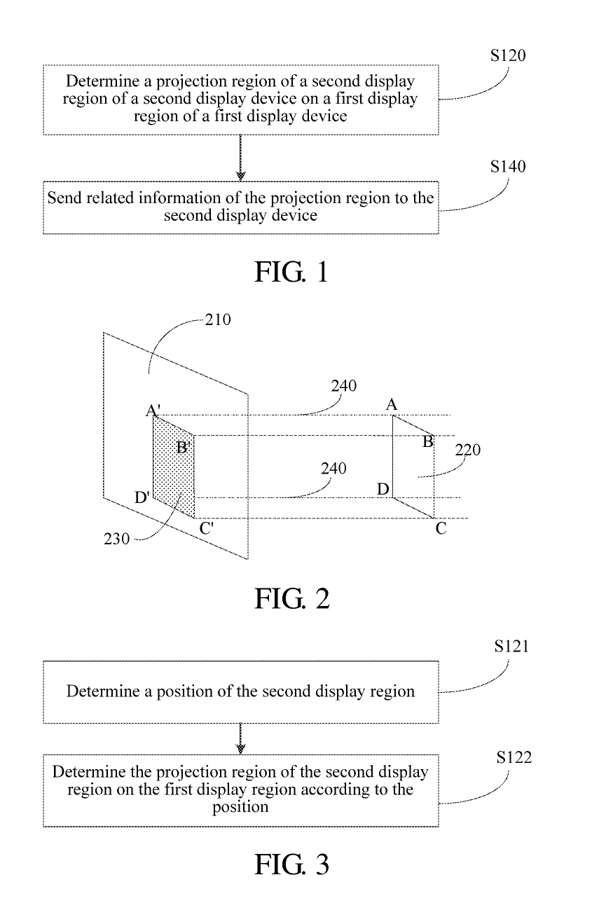

FIG. 1 is a flowchart of the content sharing method according to one embodiment of the present application. The method may be implemented on, for example, a content sharing apparatus. As shown in FIG. 1, the method comprises:

S120: determining a projection region of a second display region of a second display device on a first display region of a first display device; and

S140: sending related information of the projection region to the second display device.

The content sharing method according to this embodiment of the present application determines a projection region of a second display region of a second display device on a first display region of a first display device, and then sends related information of the projection region to the second display device, that is to say, a user can receive content of interest on the second display device only by adjusting the position of the first display device or the second display device to cause the projection region to cover the content of interest in the first display region, thereby simplifying content sharing steps, improving content sharing efficiency and enhancing user experience.

The first display region may be a virtual display region or a real display region, and the second display region may be a virtual display region or a real display region.

The functions of steps S120 and S140 will be described below in detail in combination with example embodiments.

S120: Determine a projection region of a second display region of a second display device on a first display region of a first display device.

The first display device may be a display device whose resolution is lower than that of the second display device, for example, a transparent screen device; and the second display device, for example, may be a smart phone or the like.

In one example embodiment, referring to FIG. 2, suppose that the first display region 210 and the second display region 220 are both rectangular, the projection region 230 of the second display region 220 on the first display region 210 is as shown in FIG. 2. In this example embodiment, the projection region is an orthographic projection region, that is, a projection line 240 is perpendicular to a projection plane (the plane where the first display region 210 is). However, the present application does not limit that the projection region is only an orthographic projection region, which may also be a central projection region.

Referring to FIG. 3, in one example embodiment, step S120 may comprise:

S121: determining a position of the second display region; and

S122: determining the projection region of the second display region on the first display region according to the position.

In one example embodiment, the position of the second display region may be determined by receiving visible light information of the second display device. By taking FIG. 2 as an example, four vertexes A, B, C and D of the second display region 220 may send visible light information respectively, the position of the second display region 220 can be determined according to the visible light information, then corresponding four projection points A′, B′, C′ and D′ of the vertexes A, B, C and D on the first display region 210 can be obtained, and the projection region 230 can be obtained by connecting the four projection points A′, B′, C′ and D′.

In another example embodiment, the position of the second display region may be determined by receiving sound wave information of the second display device. By still taking FIG. 2 as an example, four vertexes A, B, C and D of the second display region 220 may send sound wave information respectively, the position of the second display region 220 can be determined according to the sound wave information, then corresponding four projection points A′, B′, C′ and D′ of the vertexes A, B, C and D on the first display region 210 can be obtained, and the projection region 230 can be obtained by connecting the four projection points A′, B′, C′ and D′.

Those skilled in the art understand that, when the shape of the second display region is not regular, for example, the second display region has a curved edge, the position of the second display region can be determined at least according to a predetermined number of points on the edge of the second display region.

In this embodiment, the position of the second display region is determined according to visible light information or sound wave information, which can make the user perceive that the projection region is being determined currently, so as to prompt the user that the position of the first display device or the second display device can be adjusted, to ensure that content that the user is interested in is in the projection region. However, this embodiment is not limited to determining the position of the second display region according to visible light information or sound wave information, and the position of the second display region may also be determined in, for example, infrared, microwave and other communication manners or in a manner of photographing the second display device and performing image processing.

In addition, in the event that the projection region is a central projection region, in step S122, the projection region is determined according to the position of the second display region and a position of a reference point, and the position of the reference point corresponds to a position of a point light source in central projection, which generally may be preset or acquired according to a user instruction.

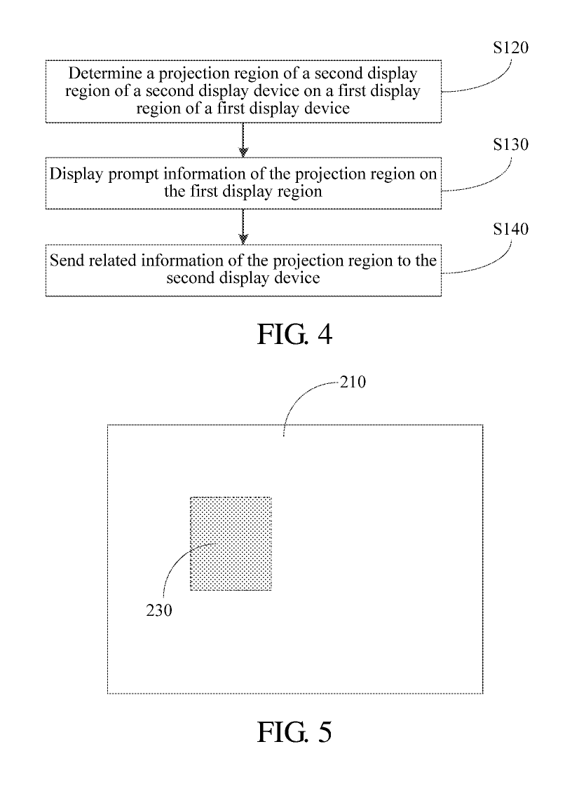

In order to better guide the user to adjust the position of the first display device or the second display device to make the content in which the user is interested in the projection region, in one example embodiment, referring to FIG. 4, the method further comprises:

S130: Display prompt information of the projection region on the first display region.

Referring to FIG. 5, the prompt information may be a dotted box displayed on the first display region 210, and a region encircled by the dotted box is the projection region 230. In response to that the user adjusts the position of the first display device or the second display device, that is, opposite positions of the first display device and the second display device are adjusted, the dotted box will change its position on the first display region 210, and thus the user can put the content that the user is interested in into the projection region 230 encircled by the dotted box more conveniently.

S140: Send related information of the projection region to the second display device.

In this step, the related information of the projection region may be sent to the second display device in response to an input instruction (for example, a voice instruction of the user), or the related information of the projection region may be sent to the second display device in response to that the projection region remains unchanged for a predetermined time (for example, 5 s). In this step, the projection region is a part of the first display region, therefore, compared with that related information of the entire first display region is sent to the second display device and then the second display device processes and obtains a region that the user is interested in, the method of the present application is more conductive to reducing network traffic.

In one example embodiment, the related information of the projection region comprises: display content of the projection region. The display content may be an image, a map, a document, an application window or the like.

In another example embodiment, the related information of the projection region comprises: display content of the projection region, and associated information of the display content. For example, if the display content of the projection region is a local map of a certain city, the associated information may comprise views of different enlarged scales of the local map. Thus, after obtaining the related information of the projection region, the user can perform a zooming operation on the local map on the second display device.

In another example embodiment, the related information of the projection region comprises: coordinate information of display content of the projection region. For example, if a local map of a certain city is displayed in the projection region, the coordinate information is coordinate information (that is, latitude and longitude information) of two diagonal vertices (suppose that the projection region is rectangular) of the local map, and according to the coordinate information, the second display device can take a screenshot of the local map on a map stored locally and display the local map to the user.

In addition, the embodiment of the present application further provides a computer readable medium, comprising a computer readable instruction that performs the following operations when being executed: executing the operations of step S120 and S140 of the method in the example embodiment shown in FIG. 1.

To sum up, according to the method in the embodiment of the present application, a projection region of a second display region of a second display device on a first display region of a first display device can be determined, then related information of the projection region is sent to the second display device, and prompt information can be displayed to prompt a user to adjust opposite positions of the first display device and the second display device, so as to help the user to place a region of interest on the first display region in the projection region, thus simplifying an operation step of sharing a part of display content on the first display device to the second display device, improving content sharing efficiency and enhancing user experience.

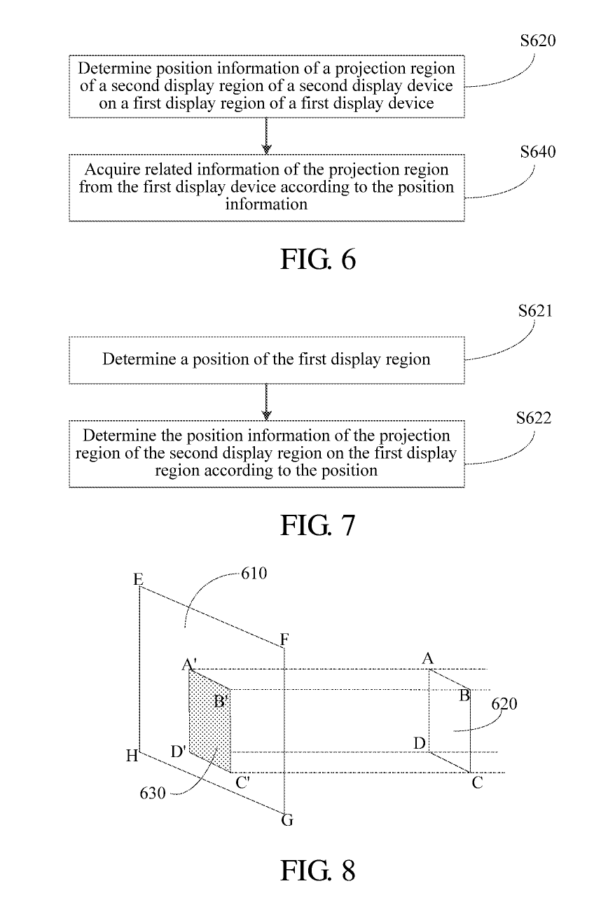

FIG. 6 is a flowchart of the content sharing method according to another embodiment of the present application, the method may be implemented, for example, on a content sharing apparatus, and as shown in FIG. 6, the method may comprise:

S620: determining position information of a projection region of a second display region of a second display device on a first display region of a first display device; and

S640: acquiring related information of the projection region from the first display device according to the position information.

The content sharing method according to this embodiment of the present application determines position information of a projection region of a second display region of a second display device on a first display region of a first display device, and then acquires related information of the projection region from the first display device according to the position information, that is to say, a user can receive content of interest on the second display device only by adjusting the position of the first display device or the second display device to put the content of interest in the first display region into the projection region, thereby simplifying content sharing steps, improving content sharing efficiency and enhancing user experience.

The functions of steps S620 and S640 will be described below in detail in combination with example embodiments.

S620: Determine position information of a projection region of a second display region of a second display device on a first display region of a first display device.

The first display device may be a display device whose resolution is lower than that of the second display device, for example, a transparent screen device; and the second display device, for example, may be a smart phone or the like.

Referring to FIG. 7, in one example embodiment, step S620 may comprise:

S621: determining a position of the first display region; and

S622: determining the position information of the projection region of the second display region on the first display region according to the position.

In one example embodiment, the position of the first display region may be determined by receiving visible light information of the first display device. By taking FIG. 8 as an example, four vertexes E, F, G and H of the first display region 610 may send visible light information respectively, the position of the first display region can be determined according to the visible light information, then corresponding four projection points A′, B′, C′ and D′ of four vertexes A, B, C and D of the second display region 620 on the first display region 610 can be obtained, and the projection region 630 can be obtained by connecting the four projection points A′, B′, C′ and D′.

In another example embodiment, the position of the first display region may be determined by receiving sound wave information of the first display device. By still taking FIG. 8 as an example, four vertexes E, F, G and H of the first display region 610 may send sound wave information respectively, the position of the first display region can be determined according to the sound wave information, then corresponding four projection points A′, B′, C′ and D′ of four vertexes A, B, C and D of the second display region 620 on the first display region 610 can be obtained, and the projection region 630 can be obtained by connecting the four projection points A′, B′, C′ and D′.

Those skilled in the art understand that, when the shape of the first display region is not regular, for example, the first display region has a curved edge, the position of the first display region can be determined at least according to a predetermined number of points on the edge of the first display region.

In addition, in this embodiment, the position of the first display region is determined according to visible light information or sound wave information, which can make the user perceive that the projection region is being determined currently, so as to prompt the user that the position of the first display device or the second display device can be adjusted, to ensure that content that the user is interested in is in the projection region. However, this embodiment is not limited to determining the position of the first display region according to visible light information or sound wave information, and the position of the first display region may also be determined in, for example, infrared, microwave and other communication manners or in a manner of photographing the first display device and performing image processing.

The two example embodiments are both described by taking that the projection region is an orthographic projection region as an example, but the present application does not limit that the projection region is only an orthographic projection region, which may also be a central projection region. In the event that the projection region is a central projection region, in step S622, the projection region is determined according to the position of the second display region and a position of a reference point, and the position of the reference point corresponds to a position of a point light source in central projection, which generally may be preset or acquired according to a user instruction.

S640: Acquire related information of the projection region from the first display device according to the position information.

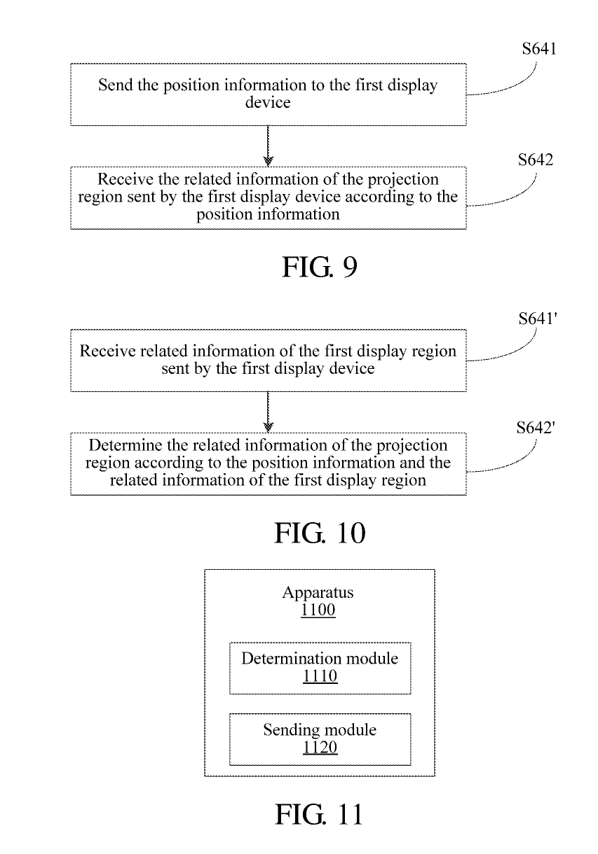

Referring to FIG. 9, in one example embodiment, step S640 may comprise:

S641: sending the position information to the first display device; and

S642: receiving the related information of the projection region sent by the first display device according to the position information.

By taking FIG. 8 as an example, in step S641, coordinates of four projection points A′, B′, C′ and D′ can be sent to the first display device, and the first display device can determine the projection region in the first display region according to the coordinates of the four projection points A′, B′, C′ and D′, and then feeds back related information of the projection region.

Referring to FIG. 10, in another example embodiment, step S640 may comprise:

S641′: receiving related information of the first display region sent by the first display device; and

S642′: determining the related information of the projection region according to the position information and the related information of the first display region.

In the previous example embodiment, the first display device determines the related information of the projection region according to the related information of the first display region and the position information; the example embodiment is different from the previous example embodiment in that, the execution body of the method, for example, the content sharing apparatus, previously receives related information of the entire first display region, and then computes the related information of the projection region in combination with the position information. In comparison, the previous example embodiment is conducive to reducing network traffic, but in such embodiment, the first display device is to have certain computation capability; the example embodiment is applicable to the situation where the first display device has weaker computation capability.

The related information of the projection region may comprise: display content of the projection region. The display content may be an image, a map, a document, an application window or the like.

Alternatively, the related information of the projection region may comprise: display content of the projection region, and associated information of the display content. For example, if the display content of the projection region is a local map of a certain city, the associated information may comprise views of different enlarged scales of the local map. Thus, the user can perform a zooming operation on the local map on the second display device.

Alternatively, the related information of the projection region may comprise: coordinate information of display content of the projection region. For example, if a local map of a certain city is displayed in the projection region, the coordinate information is coordinate information (that is, latitude and longitude information) of two diagonal vertices of the local map, and according to the coordinate information, the second display device can take a screenshot of the local map on a map stored locally and display the local map to the user.

The related information of the projection region is a part of the related information of the first display region, therefore, the related information of the first display region may comprise: display content of the first display region, or display content of the first display region and associated information of the display content, or coordinate information of the first display region.

In addition, the embodiment of the present application further provides a computer readable medium, comprising a computer readable instruction that performs the following operations when being executed: executing the operations of step S620 and S640 of the method in the example embodiment shown in FIG. 6.

FIG. 11 is a schematic diagram of a modular structure of the content sharing apparatus according to one embodiment of the present application. As shown in FIG. 11, the apparatus 1100 may comprise:

a determination module 1110, configured to determine a projection region of a second display region of a second display device on a first display region of a first display device; and

a sending module 1120, configured to send related information of the projection region to the second display device.

The content sharing apparatus according to this embodiment of the present application determines a projection region of a second display region of a second display device on a first display region of a first display device, and then sends related information of the projection region to the second display device, that is to say, a user can receive content of interest on the second display device only by adjusting the position of the first display device or the second display device to put the content of interest in the first display region into the projection region, thereby simplifying content sharing steps, improving content sharing efficiency and enhancing user experience.

The functions of the determination module 1110 and the sending module 1120 will be described below in detail in combination with example embodiments.

The determination module 1110 is configured to determine a projection region of a second display region of a second display device on a first display region of a first display device.

The first display device may be a display device whose resolution is lower than that of the second display device, for example, a transparent screen device; and the second display device, for example, may be a smart phone or the like. The content sharing apparatus 1100 can be integrated on the first display device as a functional module.

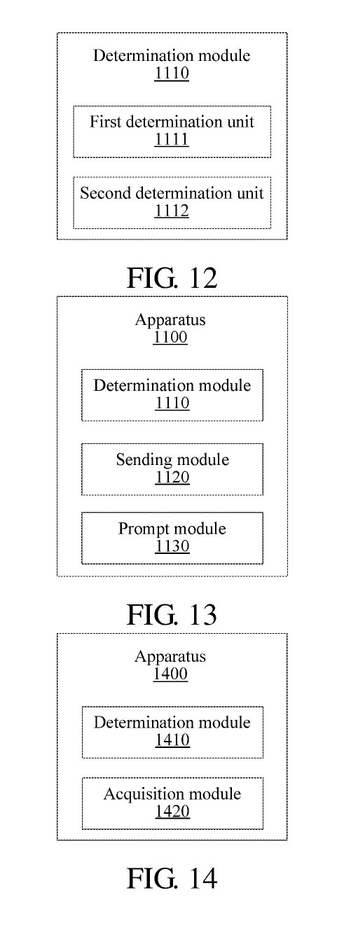

Referring to FIG. 12, in one example embodiment, the determination module 1110 may comprise:

a first determination unit 1111, configured to determine a position of the second display region; and

a second determination unit 1112, configured to determine the projection region of the second display region on the first display region according to the position.

In one example embodiment, the first determination unit 1111 is configured to determine the position of the second display region by receiving visible light information of the second display device.

In another example embodiment, the first determination unit 1111 is configured to determine the position of the second display region by receiving sound wave information of the second display device.

In order to better guide the user to adjust the position of the first display device or the second display device to make the content in which the user is interested in the projection region, in one example embodiment, referring to FIG. 13, the apparatus 1100 further comprises:

a prompt module 1130, configured to display prompt information of the projection region on the first display region.

The sending module 120 is configured to send related information of the projection region to the second display device.

The sending module 120 may send the related information of the projection region to the second display device in response to an input instruction (for example, a key instruction of the user), or send the related information of the projection region to the second display device in response to that the projection region remains unchanged for a predetermined time (for example, 5 s).

In one example embodiment, the related information of the projection region comprises: display content of the projection region. The display content may be an image, a map, a document, an application window or the like.

In one example embodiment, the related information of the projection region comprises: display content of the projection region, and associated information of the display content. For example, if the display content of the projection region is a local map of a certain city, the associated information may comprise views of different enlarged scales of the local map. Thus, the user can perform a zooming operation on the local map on the second display device.

In another example embodiment, the related information of the projection region comprises: coordinate information of display content of the projection region. For example, if a local map of a certain city is displayed in the projection region, the coordinate information is coordinate information (that is, latitude and longitude information) of two diagonal vertices of the local map, and according to the coordinate information, the second display device can take a screenshot of the local map on a map stored locally and display the local map to the user.

To sum up, the apparatus according to the embodiment of the present application can determine a projection region of a second display region of a second display device on a first display region of a first display device, then sends related information of the projection region to the second display device, and can display prompt information to prompt a user to adjust opposite positions of the first display device and the second display device, so as to help the user to place a region of interest on the first display region in the projection region, thus simplifying an operation step of sharing a part of display content on the first display device to the second display device, improving content sharing efficiency and enhancing user experience.

FIG. 14 is a schematic diagram of a modular structure of the content sharing apparatus according to another embodiment of the present application; as shown in FIG. 14, the apparatus 1400 may comprise:

a determination module 1410, configured to determine position information of a projection region of a second display region of a second display device on a first display region of a first display device; and

an acquisition module 1420, configured to acquire related information of the projection region from the first display device according to the position information.

The content sharing apparatus according to this embodiment of the present application determines position information of a projection region of a second display region of a second display device on a first display region of a first display device, and then acquires related information of the projection region from the first display device according to the position information, that is to say, a user can receive content of interest on the second display device only by adjusting the position of the first display device or the second display device to put the content of interest in the first display region into the projection region, thereby simplifying content sharing steps, improving content sharing efficiency and enhancing user experience.

The functions of the determination module 1410 and the acquisition module 1420 will be described below in detail in combination with example embodiments.

The determination module 1410 is configured to determine position information of a projection region of a second display region of a second display device on a first display region of a first display device.

The first display device may be a display device whose resolution is lower than that of the second display device, for example, a transparent screen device; and the second display device, for example, may be a smart phone or the like. The content sharing apparatus 1400 can be integrated on the second display device as a functional module.

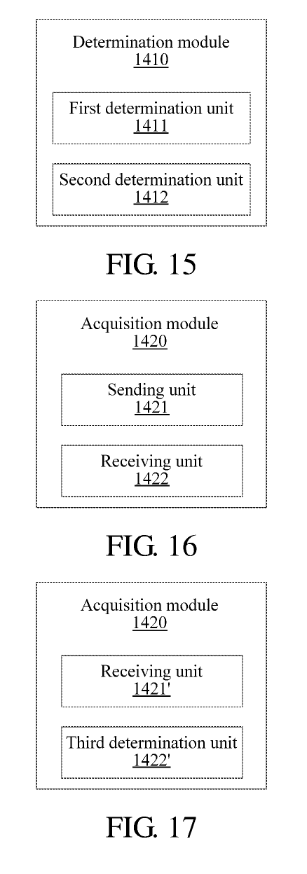

Referring to FIG. 15, in one example embodiment, the determination module 1410 may comprise:

a first determination unit 1411, configured to determine a position of the first display region; and

a second determination unit 1412, configured to determine the position information of the projection region of the second display region on the first display region according to the position.

In one example embodiment, the first determination unit 1411 is configured to determine the position of the first display region by receiving visible light information of the first display device.

In another example embodiment, the first determination unit 1411 is configured to determine the position of the first display region by receiving sound wave information of the first display device.

The acquisition module 1420 is configured to acquire related information of the projection region from the first display device according to the position information.

Referring to FIG. 16, in one example embodiment, the acquisition module 1420 may comprise:

a sending unit 1421, configured to send the position information to the first display device; and

a receiving unit 1422, configured to receive the related information of the projection region sent by the first display device according to the position information.

Referring to FIG. 17, in another example embodiment, the acquisition module 1420 may comprise:

a receiving unit 1421′, configured to receive related information of the first display region sent by the first display device; and

a third determination unit 1422′, configured to determine the related information of the projection region according to the position information and the related information of the first display region.

The related information of the projection region may comprise: display content of the projection region. The display content may be an image, a map, a document, an application window or the like.

Alternatively, the related information of the projection region may comprise: display content of the projection region, and associated information of the display content. For example, if the display content of the projection region is a local map of a certain city, the associated information may comprise views of different enlarged scales of the local map. Thus, the user can perform a zooming operation on the local map on the second display device.

Alternatively, the related information of the projection region may comprise: coordinate information of display content of the projection region. For example, if a local map of a certain city is displayed in the projection region, the coordinate information is coordinate information (that is, latitude and longitude information) of four vertices of the local map, and according to the coordinate information, the second display device can take a screenshot of the local map on a map stored locally and display the local map to the user.

The related information of the projection region is a part of the related information of the first display region, therefore, the related information of the first display region may comprise: display content of the first display region, or display content of the first display region and associated information of the display content, or coordinate information of the first display region.

One application scenario of the content sharing methods and apparatuses of the present application may be as follows: a user uses a tablet computer having a transparent screen to browse photos, when seeing a group photo comprising his/her own head, he/she wants to transmit the part of his/her own head in the photo to his/her smart phone, then, the user places the smart phone below the tablet computer, holds the tablet computer to adjust the position of the transparent screen, to make his/her own head in a projection region of the phone on the transparent screen, and then says “OK” at the tablet computer, and his/her own head in the photo is transmitted to and displayed on the smart phone.

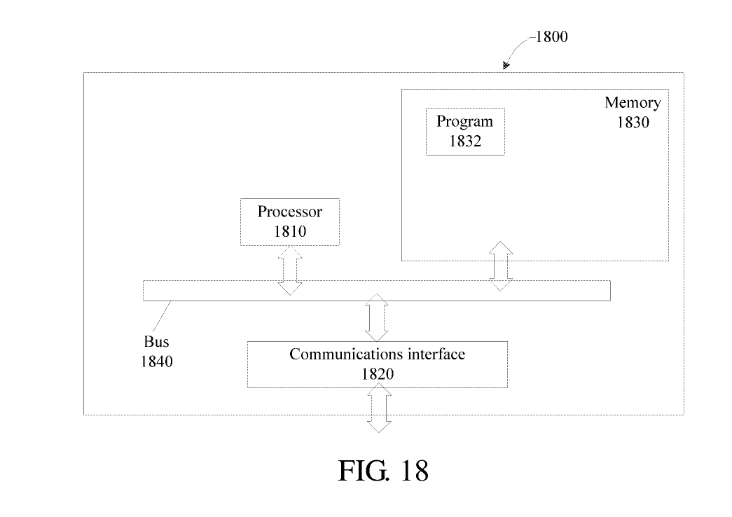

A hardware structure of the content sharing apparatus according to one embodiment of the present application is as shown in FIG. 18. The embodiment of the present application does not limit implementation of the content sharing apparatus; referring to FIG. 18, the apparatus 1800 may comprise:

a processor 1810, a Communications Interface 1820, a memory 1830, and a communications bus 1840.

The processor 1810, the Communications Interface 1820, and the memory 1830 accomplish mutual communications via the communications bus 1840.

The Communications Interface 1820 is configured to communicate with other network elements.

The processor 1810 is configured to execute a program 1832, and specifically, can implement relevant steps in the method embodiment shown in FIG. 1.

Specifically, the program 1832 may comprise a program code, the program code comprising a computer operation instruction.

The processor 1810 may be a central processing unit (CPU), or an application specific integrated circuit (ASIC), or be configured to be one or more integrated circuits which implement the embodiments of the present application.

The memory 1830 is configured to store the program 1832. The memory 1830 may comprise a high-speed RAM memory, and may also comprise a non-volatile memory, for example, at least one magnetic disk memory. The program 1832 may specifically perform the following steps of:

determining a projection region of a second display region of a second display device on a first display region of a first display device; and

sending related information of the projection region to the second display device.

Reference can be made to the corresponding description in the corresponding steps or modules in the embodiments for implementation of the steps in the program 1832, which is not repeated herein. Those skilled in the art can clearly understand that, reference can be made to the corresponding process description in the method embodiments for the devices described above and the specific working procedures of the modules, and will not be repeated herein in order to make the description convenient and concise.

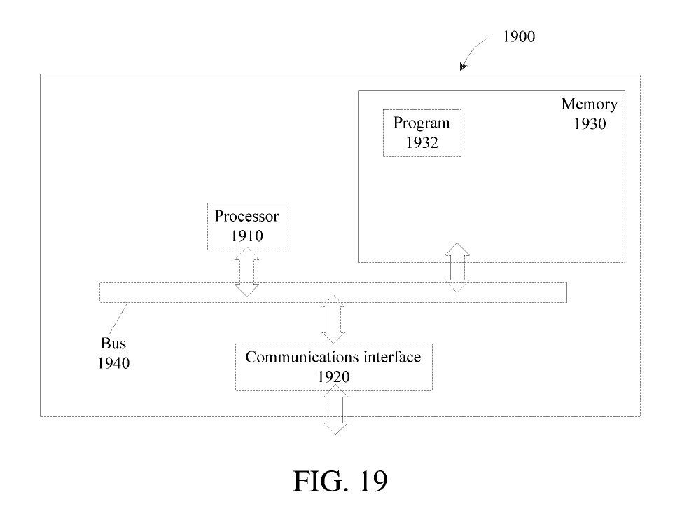

A hardware structure of the content sharing apparatus according to another embodiment of the present application is as shown in FIG. 19. The embodiment of the present application does not limit implementation of the content sharing apparatus; referring to FIG. 19, the apparatus 1900 may comprise:

a processor 1910, a Communications Interface 1920, a memory 1930, and a communications bus 1940.

The processor 1910, the Communications Interface 1920, and the memory 1930 accomplish mutual communications via the communications bus 1940.

The Communications Interface 1920 is configured to communicate with other network elements.

The processor 1910 is configured to execute a program 1932, and specifically, can implement relevant steps in the method embodiment shown in FIG. 1.

Specifically, the program 1932 may comprise a program code, the program code comprising a computer operation instruction.

The processor 1910 may be a central processing unit (CPU), or an application specific integrated circuit (ASIC), or be configured to be one or more integrated circuits which implement the embodiments of the present application.

The memory 1930 is configured to store the program 1932. The memory 1930 may comprise a high-speed RAM memory, and may also comprise a non-volatile memory, for example, at least one magnetic disk memory. The program 1932 may specifically perform the following steps of:

determining position information of a projection region of a second display region of a second display device on a first display region of a first display device; and

acquiring related information of the projection region from the first display device according to the position information.

Reference can be made to the corresponding description in the corresponding steps or modules in the embodiments for implementation of the steps in the program 1932, which is not repeated herein. Those skilled in the art can clearly understand that, reference can be made to the corresponding process description in the method embodiments for the devices described above and the specific working procedures of the modules, and will not be repeated herein in order to make the description convenient and concise.

It can be appreciated by those of ordinary skill in the art that each exemplary unit and method step described with reference to the embodiments disclosed herein can be implemented by electronic hardware or a combination of computer software and electronic hardware. Whether these functions are executed in a hardware mode or a software mode depends on particular applications and design constraint conditions of the technical solution. The professional technicians can use different methods to implement the functions described with respect to each particular application, but such example embodiment should not be considered to go beyond the scope of the present application.

If the functions are implemented in the form of a software functional unit and is sold or used as an independent product, it can be stored in a computer-readable storage medium. Based on such understanding, the technical solution of the present application essentially or the part which contributes to the prior art or a part of the technical solution can be embodied in the form of a software product, and the computer software product is stored in a storage medium, and comprises several instructions for enabling a computer device (which can be a personal computer, a controller, or a network device, and the like) to execute all or some steps of the method described in each embodiment of the present application. The foregoing storage medium comprises, a USB disk, a removable hard disk, a Read-Only Memory (ROM), a Random Access Memory (RAM), a magnetic disk, an optical disk or any other mediums that can store program codes.

The above example embodiments are only intended to describe the present application rather than to limit the present application; various changes and variations can be made by those of ordinary skill in the art without departing from the spirit and scope of the present application, so all equivalent technical solutions also belong to the category of the present application, and the scope of patent protection of the present application should be defined by the claims.

What is claimed is:

1. A method, comprising:
determining, by a system comprising a processor, a projection region of a second display region of a second display device on a first display region of a first display device; and
sending related information of the projection region to the second display device.

2. The method of claim 1, wherein the determining the projection comprises:
determining a position of the second display region; and
determining the projection region of the second display region on the first display region according to the position.

3. The method of claim 2, wherein the position of the second display region is determined by receiving visible light information of the second display device.

4. The method of claim 2, wherein the position of the second display region is determined by receiving sound wave information of the second display device.

5. The method of claim 1, further comprising:
displaying prompt information of the projection region on the first display region.

6. The method of claim 1, wherein the related information of the projection region comprises: display content of the projection region.

7. The method of claim 1, wherein the related information of the projection region comprises: display content of the projection region, and associated information of the display content.

8. The method of claim 1, wherein the related information of the projection region comprises: coordinate information of display content of the projection region.

9. The method of claim 1, wherein a second resolution of the second display device is higher than a first resolution of the first display device.

10. The method of claim 1, wherein the projection region is an orthographic projection region.

11. The method of claim 1, wherein the projection region is a central projection region.

12. A method, comprising:
determining, by a system comprising a processor, position information of a projection region of a second display region of a second display device on a first display region of a first display device; and
acquiring related information of the projection region from the first display device according to the position information.

13. The method of claim 12, wherein the determining the position information comprises:
determining a position of the first display region; and
determining the position information of the projection region of the second display region on the first display region according to the position.

14. The method of claim 13, wherein the position of the first display region is determined by receiving visible light information of the first display device.

15. The method of claim 13, wherein the position of the first display region is determined by receiving sound wave information of the first display device.

16. The method of claim 12, wherein the acquiring the related information comprises:
sending the position information to the first display device; and
receiving the related information of the projection region sent by the first display device according to the position information.

17. The method of claim 12, wherein the acquiring the related information comprises:
receiving related information of the first display region sent by the first display device; and
determining the related information of the projection region according to the position information and the related information of the first display region.

18. The method of claim 12, wherein the related information of the projection region comprises: display content of the projection region.

19. The method of claim 12, wherein the related information of the projection region comprises: display content of the projection region, and associated information of the display content.

20. The method of claim 12, wherein the related information of the projection region comprises: coordinate information of display content of the projection region.

21. The method of claim 12, wherein a resolution of the second display device is higher than another resolution of the first display device.

22. The method of claim 12, wherein the display region is an orthographic projection region.

23. The method of claim 12, wherein the display region is a central projection region.

24. An apparatus, comprising:
a memory that stores executable modules; and
a processor, coupled to the memory, that executes or facilitates execution of the executable modules, comprising:
a determination module configured to determine a projection region of a second display region of a second display device on a first display region of a first display device; and
a sending module configured to send related information of the projection region to the second display device.

25. The apparatus of claim 24, wherein the determination module comprises:
a first determination unit configured to determine a position of the second display region; and
a second determination unit configured to determine the projection region of the second display region on the first display region according to the position.

26. The apparatus of claim 25, wherein the first determination unit determines the position of the second display region by receiving visible light information of the second display device.

27. The apparatus of claim 25, wherein the first determination unit determines the position of the second display region by receiving sound wave information of the second display device.

28. The apparatus of claim 24, wherein the executable modules further comprise:
a prompt module configured to display prompt information of the projection region on the first display region.

29. An apparatus, comprising:
a memory that stores executable modules; and
a processor, coupled to the memory, that executes or facilitates execution of the executable modules, comprising:
a determination module configured to determine position information of a projection region of a second display region of a second display device on a first display region of a first display device; and
an acquisition module configured to acquire related information of the projection region from the first display device according to the position information.

30. The apparatus of claim 29, wherein the determination module comprises:
a first determination unit configured to determine a position of the first display region; and
a second determination unit configured to determine the position information of the projection region of the second display region on the first display region according to the position.

31. The apparatus of claim 30, wherein the first determination unit determines the position of the first display region by receiving visible light information of the first display device.

32. The apparatus of claim 30, wherein the first determination unit determines the position of the first display region by receiving sound wave information of the first display device.

33. The apparatus of claim 29, wherein the acquisition module comprises:
a sending unit configured to send the position information to the first display device; and
a receiving unit configured to receive the related information of the projection region sent by the first display device according to the position information.

34. The apparatus of claim 29, wherein the acquisition module comprises:
a receiving unit configured to receive related information of the first display region sent by the first display device; and
a third determination unit configured to determine the related information of the projection region according to the position information and the related information of the first display region.

35. A computer readable storage apparatus, comprising at least one executable instruction, which, in response to execution, causes an apparatus comprising a processor to perform operations, comprising:
determining a projection region of a second display region of a second display device on a first display region of a first display device; and
sending related information of the projection region to the second display device.

36. An apparatus, characterized by comprising a processor and a memory, the memory storing executable instructions, the processor being connected to the memory via a communication bus, and when the apparatus operates, the processor executes the executable instructions stored in the memory, so that the apparatus executes operations, comprising:
determining a projection region of a second display region of a second display device on a first display region of a first display device; and
sending related information of the projection region to the second display device.

37. A computer readable storage apparatus, comprising at least one executable instruction, which, in response to execution, causes an apparatus comprising a processor to perform operations, comprising:
determining position information of a projection region of a second display region of a second display device on a first display region of a first display device; and
acquiring related information of the projection region from the first display device according to the position information.

38. An apparatus, characterized by comprising a processor and a memory, the memory storing executable instructions, the processor being connected to the memory via a communication bus, and when the apparatus operates, the processor executes the executable instructions stored in the memory, so that the apparatus executes operations, comprising:
determining position information of a projection region of a second display region of a second display device on a first display region of a first display device; and
acquiring related information of the projection region from the first display device according to the position information.
